(19) United States
(12) Patent Application Publication
(10) Pub. No.: US 2024/0120551 A1
(43) Pub. Date: Apr. 11, 2024

(54) DEVICE FOR INTERCEPTING PICKUP OF MULTIPLE ELECTRODES

(71) Applicants: Hyundai Motor Company, Seoul (KR); Kia Corporation, Seoul (KR)

(72) Inventor: Kyung Mo KIM, Hwaseong-si (KR)

(21) Appl. No.: 18/198,155

(22) Filed: May 16, 2023

(30) Foreign Application Priority Data
Oct. 7, 2022 (KR) 1020220128279

(51) Int. Cl. H01M 10/0583

(52) U.S. Cl. CPC H01M 10/0583

(57) ABSTRACT

The present disclosure relates to a secondary battery, and more particularly to an electrode of a battery. A device for intercepting pickup of multiple electrodes includes a variable jig movable between a first position and a second position, wherein the variable jig is configured to allow a first-type electrode including a first mark to be picked up at the first position and to allow a second-type electrode including a second mark to be picked up at the second position.

### CROSS-REFERENCE TO RELATED APPLICATION

This application claims, under 35 U.S.C. § 119(a), the benefit of priority to Korean Patent Application No. 10-2022-0128279 filed on Oct. 7, 2022, the entire contents of which are incorporated herein by reference.

### TECHNICAL FIELD

The present disclosure relates to a secondary battery and, more particularly, to an electrode of a battery.

### BACKGROUND

In recent years, use of secondary batteries has increased in electronic devices, electric vehicles, energy storage systems, etc. Among secondary batteries, lithium ion batteries are among the most widely used.

A unit cell of the lithium ion battery can be manufactured by sealingly placing an electrode assembly including a positive electrode, a negative electrode, and a separator in a prismatic, pouch-shaped, or cylindrical enclosure. The electrode assembly may be manufactured as shown in FIG. 1A. First, positive electrodes 820 and negative electrodes 840 are cut to have a predetermined area, and a separator 860 is folded so as to continuously have a Z shape. The positive electrodes 820 and the negative electrodes 840 are alternately inserted between the folded portions of the separator 860, whereby an electrode assembly may be manufactured. The manufactured electrode assembly is pressed and is then inserted into an enclosure, and subsequent processes are carried out.

Electrodes 800 are picked up from an electrode stack 810, such as a positive electrode stack 830 or a negative electrode stack 850 and are supplied to the separator 860. The electrodes are picked up and transferred by a pick and place (“P&P”) unit 870, and the electrodes must be picked up one by one. Sometimes, however, two or more neighboring electrodes that are stacked may be picked up. As shown in FIG. 1B, vibrations can be applied to the P&P unit 870 when the electrodes are picked up as a method of preventing pickup of multiple electrodes. Specifically, a method of the P&P unit 870 mechanically generating vibration to drop one of two simultaneously picked-up electrodes 800a and 800b, e.g., the lower electrode 800b, is typically used.

### SUMMARY

It is an object of the present disclosure to provide a device for intercepting pickup of multiple electrodes capable of preventing damage to an electrode that may occur by vibration applied to achieve conventional multiple electrode pickup prevention.

It is another object of the present disclosure to provide a device for intercepting pickup of multiple electrodes configured such that a vibration application process is omitted, whereby it is possible to reduce process time.

It is another object of the present disclosure to provide a device for intercepting pickup of multiple electrodes operable without addition of a separate process through minor change of the conventional process, whereby it is possible to provide an economic advantage.

It is a further object of the present disclosure to provide a device for intercepting pickup of multiple electrodes capable of physically preventing pickup of multiple electrodes, whereby it is possible to prevent pickup of multiple electrodes with very high probability.

The objects of the present disclosure are not limited to those described above, and other unmentioned objects of the present disclosure will be clearly understood by a person of ordinary skill in the art (hereinafter referred to as an “ordinary skilled person”) from the following description.

Features of the present disclosure to accomplish the above objects and to perform the following characteristic functions may include the following.

In one aspect, the present disclosure provides a device for intercepting pickup of multiple electrodes. The device includes a variable jig movable between a first position and a second position, wherein the variable jig is configured to allow a first-type electrode including a first mark to be picked up at the first position and to allow a second-type electrode including a second mark to be picked up at the second position.

In another aspect, the present disclosure provides a method of operating a device for intercepting pickup of multiple electrodes. The method includes alternately stacking a first-type electrode having a first mark and a second-type electrode having a second mark on a tray disposed in a variable jig, moving the variable jig to a first position when an electrode disposed at a top of the tray is the first-type electrode, and picking up the first-type electrode using a transporter disposed at the top of the variable jig.

The present disclosure provides a device for intercepting pickup of multiple electrodes configured such that a vibration application process is omitted, whereby it is possible to reduce process time.

The present disclosure provides a device for intercepting pickup of multiple electrodes operable without addition of a separate process through minor change of the conventional process, whereby it is possible to provide an economic advantage.

The present disclosure provides a device for intercepting pickup of multiple electrodes capable of preventing pickup of multiple electrodes using a physical method, whereby it is possible to prevent pickup of multiple electrodes with very high probability.

The effects of the present disclosure are not limited to those mentioned above, and other unmentioned effects will be clearly understood by an ordinary skilled person from the above description.

Other aspects and preferred implementations of the disclosure are discussed infra.

### BRIEF DESCRIPTION OF THE DRAWINGS

The above and other features of the present disclosure will now be described in detail with reference to certain exemplary implementations thereof illustrated in the accompanying drawings which are given hereinbelow by way of illustration only, and thus are not limitative of the present disclosure, and wherein:

FIG. 1A is a view schematically showing an example manufacturing process of an electrode assembly for batteries;

FIG. 1B is a view showing an example multiple electrode pickup prevention method;

FIG. 2A is a view showing an example positive electrode for a device for intercepting pickup of multiple electrodes according to the present disclosure;

FIG. 2B is a view showing an example negative electrode for a device for intercepting pickup of multiple electrodes according to the present disclosure;

FIG. 3A is a view showing an example tray for a device for intercepting pickup of multiple electrodes according to the present disclosure;

FIG. 3B is an enlarged view of area S1 of FIG. 3A;

FIG. 4 is a perspective view of an example device for intercepting pickup of multiple electrodes according to the present disclosure;

FIG. 5A is an upper side view of a device for intercepting pickup of multiple electrodes according to the present disclosure, showing a first position of a variable jig;

FIG. 5B is an upper side view of a device for intercepting pickup of multiple electrodes according to the present disclosure, showing a second position of the variable jig;

FIG. 6A is a perspective view of a device for intercepting pickup of multiple electrodes according to the present disclosure;

FIG. 6B is a partial enlarged view of a dotted box of FIG. 6A;

FIG. 6C is a perspective view of the multiple electrode pickup prevention device according to the present disclosure;

FIGS. 7 and 8 are perspective views of a device for intercepting pickup of multiple electrodes according to the present disclosure;

FIGS. 9A and 9B are views schematically showing movement between the first position and the second position of the variable jig;

FIG. 10 is a view showing mechanism of a device for intercepting pickup of multiple electrodes according to the present disclosure; and

FIGS. 11 and 12 are views showing an illustrative manufacturing process of an electrode.

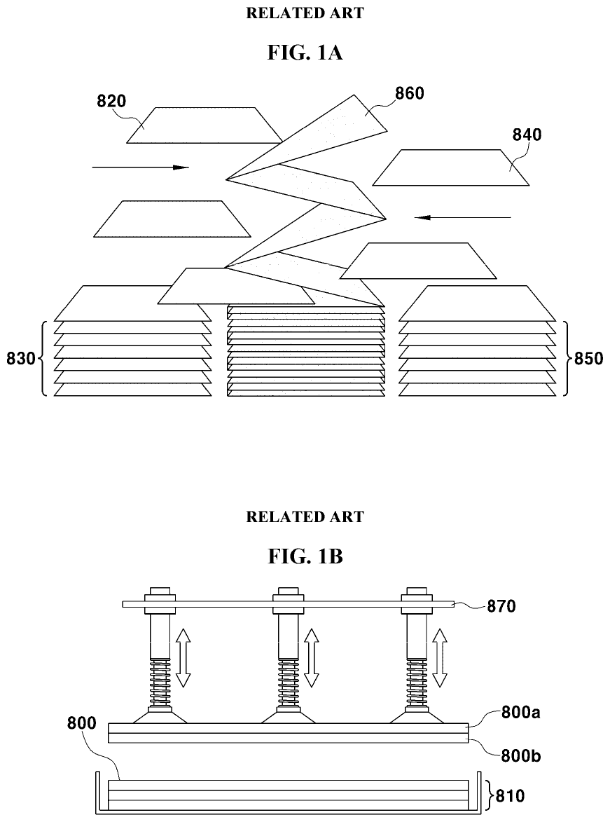

### DETAILED DESCRIPTION

Specific structural or functional descriptions of the implementations of the present disclosure disclosed in this specification are given only for illustrating implementations of the present disclosure. Implementations of the present disclosure may be implemented in various forms. In addition, the implementations according to the concept of the present disclosure are not limited to such specific implementations, and it should be understood that the present disclosure includes all alterations, equivalents, and substitutes that fall within the idea and technical scope of the present disclosure.

Hereinafter, the present disclosure will be described in detail with reference to the accompanying drawings.

The above vibration method related to pickup of multiple electrodes may be difficult to apply to a cell of a next-generation battery (an all-solid-state battery, a lithium metal battery, and the like). This is because a solid electrolyte membrane may be broken or a lithium metal layer of a negative electrode may be damaged. Specifically, an electrode is repeatedly twisted or bent upward and downward for a short period of time during vibration. At this time, an electrode coated on a surface of a current collector may be separated or damaged. In particular, for the next-generation battery, the solid electrolyte membrane or the lithium metal layer is very weak, whereby damage thereto may be further serious.

Consequently, the present disclosure proposes a device for intercepting pickup of multiple electrodes for batteries capable of preventing pickup of multiple electrodes by applying different shapes to electrodes that are alternately stacked. The device according to the present disclosure may be applied to not only electrodes of a battery but also sheets where a single sheet is to be picked up in a stack of sheets.

According to the device of the present disclosure, vibration or bending is not applied to a positive electrode or a negative electrode. Accordingly, damage that may be caused by multiple electrode pickup prevention operation can be avoided.

According to the device of the present disclosure, processing can be expedited since multiple electrode pickup is blocked while an electrode is picked up from a tray, without a separate operation, such as application of vibration. In addition, according to the present disclosure, shaping electrodes into different shapes may be done in a conventional process, whereby no additional process is required in an electrode manufacturing process, compared to the conventional process.

In some cases, application of vibration may not be able to eliminate a possibility of multiple electrode pickup due to electrostatic force between two electrodes or vacuum. However, since the device according to the present disclosure can help prevent pickup of multiple electrodes through physical shapes, it can be possible to better prevent pickup of multiple electrodes.

A device 1 for intercepting pickup of multiple electrodes according to the present disclosure may be applied to any electrode of a battery cell, i.e., a positive electrode or a negative electrode. The electrode 10 includes an electrode active material and an electrode current collector. The electrode 10 may be a positive electrode 20 or a negative electrode 30.

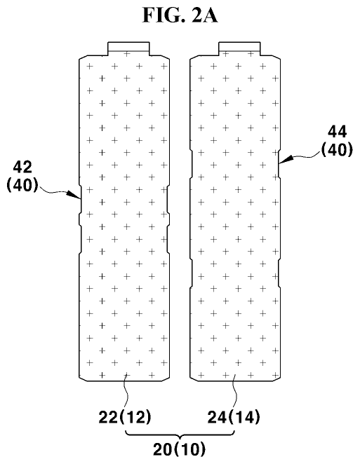

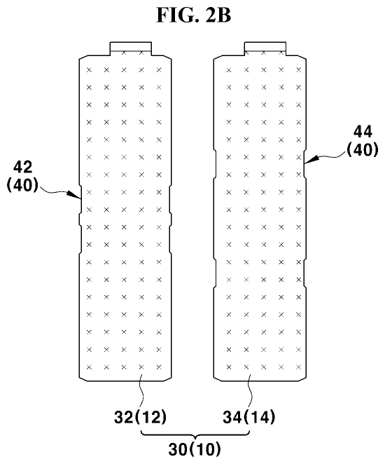

According to the present disclosure, the electrode 10 includes at least two types of electrodes. As shown in FIGS. 2A and 2B, the electrode 10 may include a first-type electrode 12 and a second-type electrode 14. The first type-electrode 12 and the second-type electrode 14 respectively include a first mark 42 and a second mark 44, which are different from each other. The first-type electrode 12 and the second-type electrode 14 are distinguished from each other by a mark 40. As a non-limiting example, the mark 40 may appear at different positions and may be made to have different shapes or numbers. In the drawings, the mark 40 is shown in the form of a notch, but another shape may be applied. The shapes, the number or the positions of the mark 40 may be changed if the first-type electrode 12 can be distinguished from the second-type electrode 14 and vice versa based on such shapes, numbers or positions thereof. As shown in FIG. 2A, the electrode 10 may be a positive electrode 20. When the electrode 10 is a positive electrode 20, the positive electrode 20 may include a first-type positive electrode 22 and a second-type positive electrode 24. The first-type positive electrode 22 and the second-type positive electrode 24 respectively include a first mark 42 and a second mark 44, which are different from other.

As shown in FIG. 2B, the electrode 10 may be a negative electrode 30. When the electrode 10 is a negative electrode 30, the negative electrode 30 may include a first-type negative electrode 32 and a second-type negative electrode 34. The first-type negative electrode 32 and a second-type negative electrode 34 respectively includes a first mark 42 and a second mark 44, which are different from each other.

Hereinafter, the term “electrode 10” will be commonly used unless the positive electrode 20 and the negative electrode 30 need to be distinguished from each other. As previously described, the electrode 10 may be a positive electrode or a negative electrode.

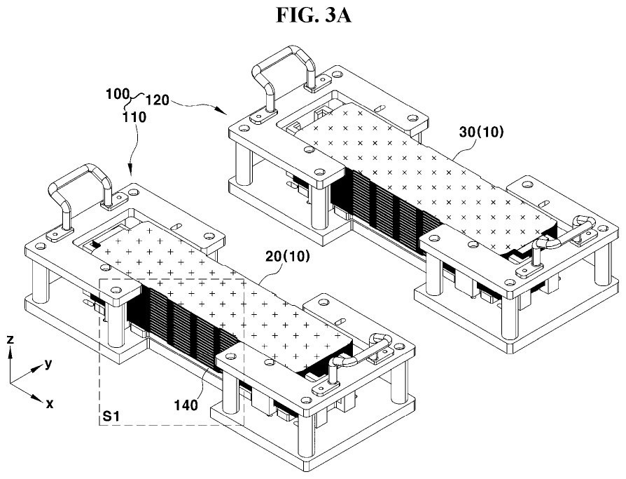

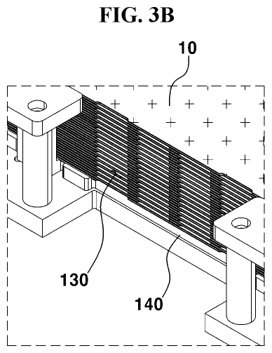

As shown in FIG. 3A, electrodes 10 may be stacked in a tray 100. In the tray 100, first-type electrodes 12 and second-type electrodes 14 are alternately stacked. Specifically, the first-type electrodes 12 and the second-type electrodes 14 are alternately stacked in one tray 100 in a vertical direction or a z-axis direction.

In one implementation, a positive electrode tray 110 for stacking positive electrodes 20 and a negative electrode tray 120 for stacking negative electrodes 30 may be separately provided. In an implementation, the positive electrode tray 110 and the negative electrode tray 120 may be integrally formed or separably assembled.

As shown in FIG. 3B, the tray 100 includes an access area 130. The access area 130 is formed such that access to the mark 40 of the electrodes 10 in the tray 100 from the outside is possible. According to an implementation of the present disclosure, a variable jig 300 may access the mark 40 of the stacked electrodes 10.

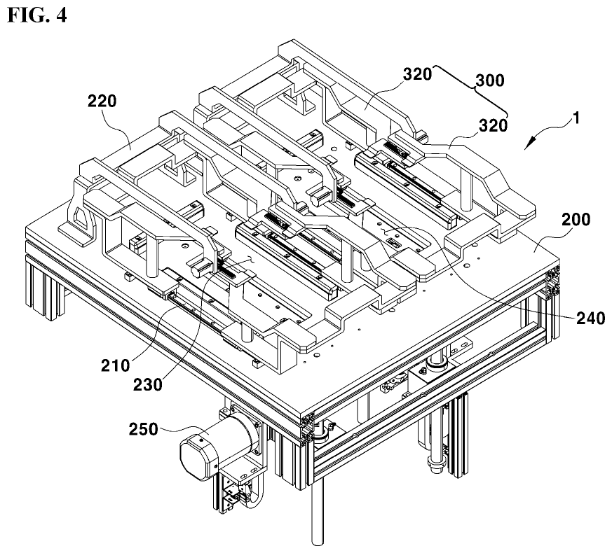

As shown in FIG. 4, the device 1 according to the present disclosure includes a base 200 and a variable jig 300.

The variable jig 300 is supported by the base 200 and movable on the base 200. In an implementation, a rail 210 is provided at the base 200. The variable jig 300 may be moved along the rail 210 by a predetermined distance.

A stationary frame 220 is provided at the base 200. The variable jig 300 is operably associated with the stationary frame 220. Movement of the variable jig 300 may be limited by the stationary frame 220. The variable jig 300 is configured to be movable in conjunction with the stationary frame 220.

A space 230 configured to receive the tray 100 is provided in the base 200. In some implementations, the tray 100 may be detachably coupled to the base 200. In some implementations, the tray 100 may be integrally formed with the base 200.

An opening 240 is provided in the base 200. Pushing force is provided through the opening 240 such that an electrode 10 can be raised as the electrode 10 is picked up from the tray 100. In an implementation, a lift actuator 250 may be provided at the base 200. The lift actuator 250 may provide driving force such that a stack plate 140 of the tray 100 can be raised.

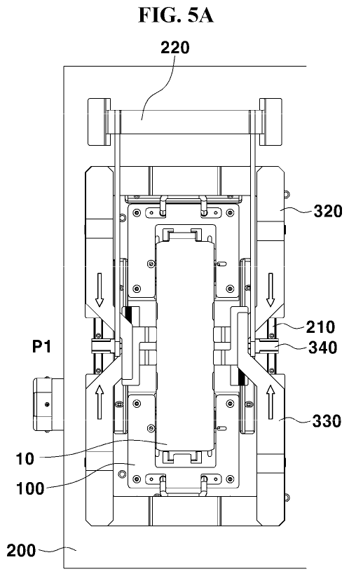

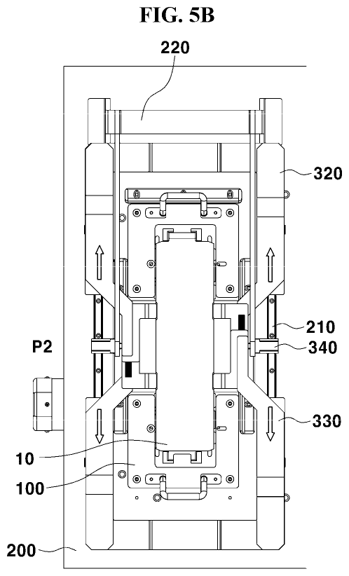

Referring to FIGS. 5A and 5B, the variable jig 300 is configured to be movable between two different positions. Specifically, the variable jig 300 may be movable between a first position P1 and a second position P2. At the first position P1 of the variable jig 300, pickup of the first-type electrode 12 may be allowed. At the second position P2 of the variable jig 300, pickup of the second-type electrode 14 may be allowed. At the first position P1, the variable jig 300 may be operated in association with the first mark 42 of the first-type electrode 12. At the second position P2, the variable jig 300 may be operated in association with the second mark 44 of the second-type electrode 14.

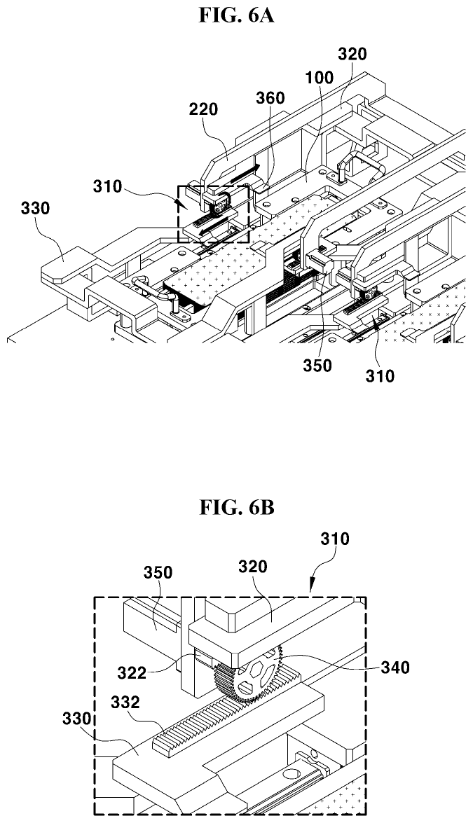

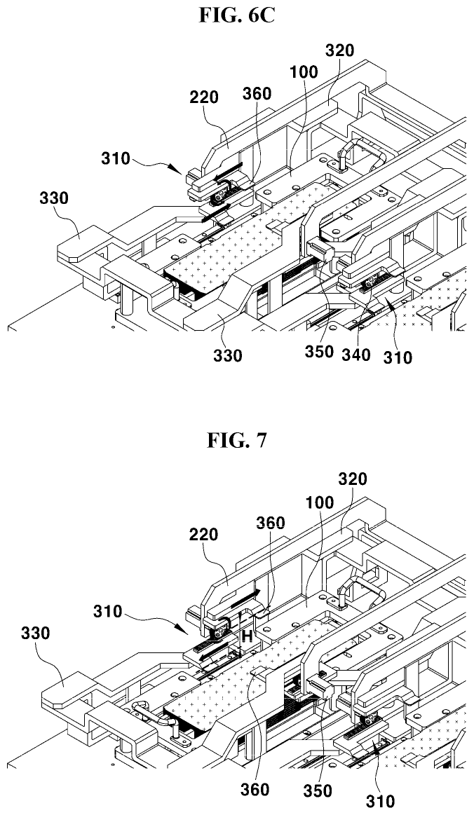

As shown in FIGS. 6A to 6C, according to an implementation of the present disclosure, the variable jig 300 includes an operation mechanism 310. The operation mechanism 310 includes a first jig 320 and a second jig 330. The first jig 320 and the second jig 330 are configured to be movable relative to each other. The first jig 320 and the second jig 330 may be moved toward each other or may be moved in opposite directions. In an implementation, the first jig 320 is provided with a first rack 322 including a plurality of teeth, and the second jig 330 is provided with a second rack 332 including a plurality of teeth. A pinion gear 340 is disposed between the first rack 322 and the second rack 332. The pinion gear 340 has a plurality of teeth formed on an outer circumferential surface thereof, and the teeth of the pinion gear 340 are configured to engage with the teeth of the first rack 322 and the second rack 332. The pinion gear 340 and a pinion actuator 350 configured to provide rotational force to the pinion gear 340 may be mounted to the stationary frame 220.

Referring to FIG. 7, in one implementation, the first jig 320 and the second jig 330 may be disposed spaced apart from each other by a height H in the vertical direction or the z-axis direction. The lower jig, e.g., the second jig 330, may be disposed in a position lower than the first jig 320. Accordingly, even though the second jig 330 may be unable to prevent pickup of multiple electrodes, pickup of multiple electrodes may still be prevented by the first jig 320.

In an implementation, a contact portion of the variable jig that contacts the electrode 10, particularly, an identifying portion 360, is made of a nonmetal material. As a non-limiting example, the identifying portion 360 may be made of plastic or urethane. The reason for this is that it can be possible to prevent damage to the electrode 10 due to contact with the electrode when the identifying portion 360 is made of metal.

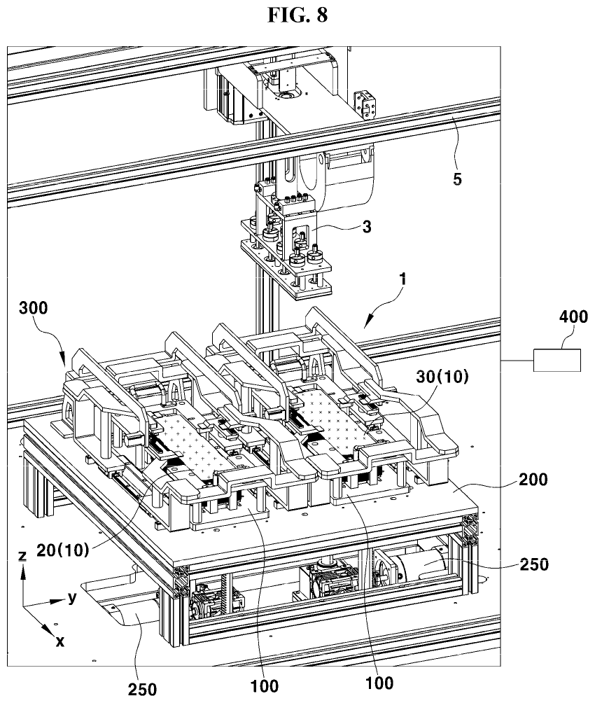

As shown in FIG. 8, the device 1 according to the present disclosure is illustratively in an operation state. A transporter 3 is configured to be movable along a railing 5. As a non-limiting example, the transporter 3 may be a P&P unit. In addition, the transporter 3 may move downward in a state of being aligned with the tray 100 in the vertical direction or the z-axis direction to pick up the electrode 10 on the tray 100, may be moved upward in the z-axis direction, and may transfer the picked-up electrode 10 to a predetermined destination while holding the electrode. The transporter 3 may receive driving force from an actuator that is driven by pneumatic pressure, hydraulic pressure, or electricity.

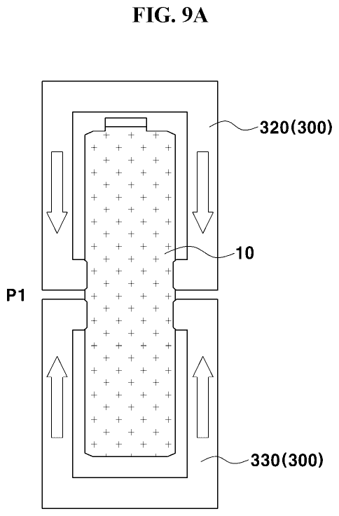

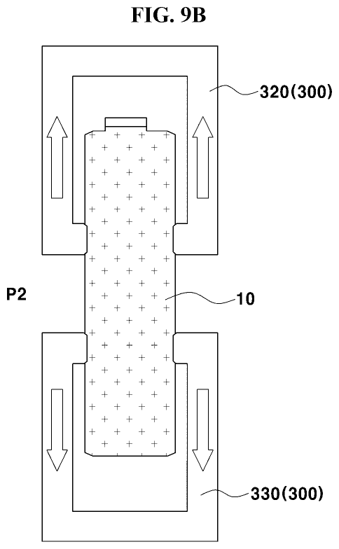

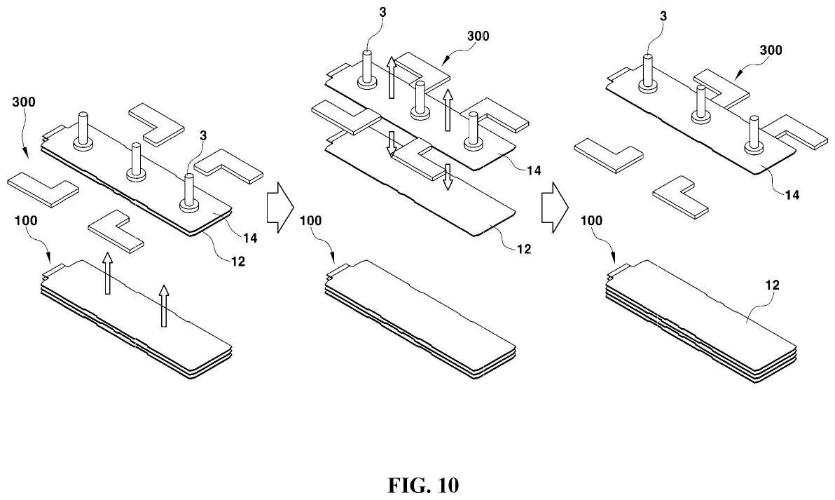

Referring to FIGS. 9A, 9B, and 10, the variable jig 300 may be operated with the transporter 3. When the transporter 3 is firstly moved downward, the variable jig 300 is placed at the first position P1. At the first position P1 of the variable jig 300, only the first-type electrode 12 having the first mark 42 may be moved upward. Only the first-type electrode 12 can pass through the identifying portion 360. The second-type electrode 14 stacked under the first-type electrode 12 cannot pass through the identifying portion 360. Even though the second-type electrode 14 is moved upward together with the first-type electrode 12 as the transporter 3 is moved upward, the second-type electrode 14 is loaded back into the tray 100 by the variable jig 300 located at the first position P1. When the transporter 3 is firstly moved downward, therefore, the transporter 3 picks up the first-type electrode 12, is moved upward, and transfers the first-type electrode 12 to a destination.

When the transporter 3 is secondly moved downward, the variable jig 300 is located at the second position P2. When the variable jig 300 is located at the second position P2, only the second-type electrode 14 having the second mark 44 can pass through the identifying portion 360 of the variable jig 300 and can be moved upward. Upward movement of the first-type electrode 12 stacked under the second-type electrode 14 is interrupted by the identifying portion 360 and is loaded back into the tray 100 even if the first-type electrode 12 is moved upward by the transporter 3. When the transporter 3 is secondly operated, therefore, the transporter 3 picks up the second-type electrode 14, is moved upward, and transfers the second-type electrode 14 to a destination. According to the present disclosure, it is possible to manufacture an electrode assembly without pickup of multiple electrodes by repeating the above process.

In the above description, the first-type electrode 12 is picked up through the first operation, and the second-type electrode 14 is picked up through the second operation. However, this is merely an example, and the second-type electrode 14 may be firstly picked up. In addition, it will be apparent to a person having ordinary skill in the art that the first position P1 and the second position P2 are interchangeable with each other.

A controller 400 configured to control the device 1 according to the present disclosure may be further included. The controller 400 may control driving of the transporter 3, driving of the variable jig 300, and driving of the stack plate 140 of the tray 100. Specifically, the controller 400 is configured to control driving of the device 1 according to a series of pre-stored commands.

According to some implementations of the present disclosure, the transporter 3 may perform a machine vision inspection function. The result of machine vision inspection by the transporter 3 is transmitted to a vision inspector included in the controller 400. When an electrode to be lifted is not a predetermined type of electrode through the inspection, it is possible to more securely prevent incorrect discharge. When errors occur, e.g., when the stacking sequence of electrodes 10 is incorrect, the vision inspector of the controller 400 may compare a target electrode to be picked up and a currently detected electrode with each other through the machine vision inspection by the transporter 3. When the target electrode and the currently detected electrode are different from each other, a visual or audio alarm may be set off to notify a worker, thereby preventing errors.

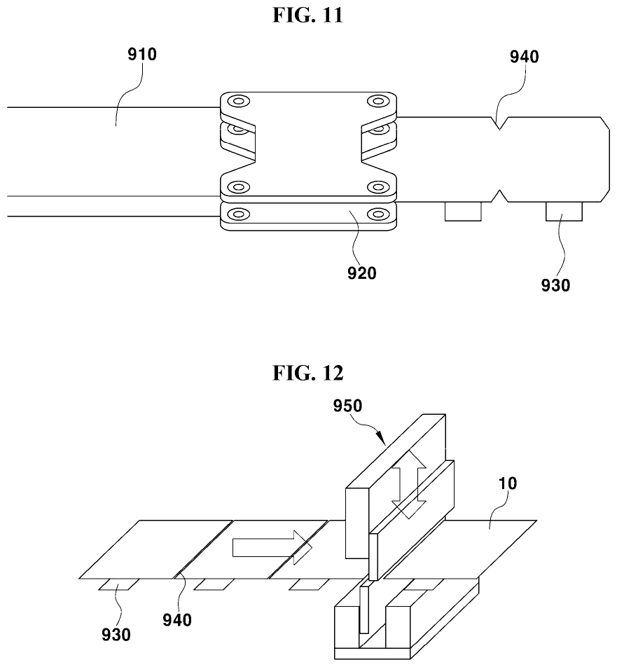

The device 1 according to the present disclosure is applicable without major change of facilities that are currently applied or addition of processes, thereby providing an economic advantage. As shown in FIGS. 11A and 11B, the electrode 10 passes through terminal processing and cutting processes. As shown in FIG. 11A, an electrode tab 930 and a cutting portion 940 are generated by a press 920 on an electrode sheet 910 that is continuously supplied. After such terminal processing, the electrode sheet 910 is continuously fed again and cut into individual electrodes 10 by a cutter 950. Since the mark 40 can be formed during the terminal processing process or the cutting process, no separate process is necessary, thereby providing an economic advantage.

The device 1 according to the present disclosure can help prevent damage to an electrode that may occur when vibration is applied to achieve conventional multiple electrode pickup prevention.

In the device 1 according to the present disclosure, a vibration application process can be omitted, whereby it can be possible to reduce process time.

The device 1 according to the present disclosure is operable without addition of a separate process through minor change of the conventional process, whereby it can be possible to provide an economic advantage.

The device 1 according to the present disclosure prevents pickup of multiple electrodes using a physical method, whereby it can be possible to prevent pickup of multiple electrodes with very high probability.

As is apparent from the foregoing, the present disclosure provides a multiple electrode pickup prevention device capable of preventing damage to an electrode that may occur by vibration applied to achieve conventional multiple electrode pickup prevention.

It will be apparent to a person of ordinary skill in the art that the present disclosure described above is not limited to the above implementations and the accompanying drawings and that various substitutions, modifications, and variations can be made without departing from the technical idea of the present disclosure.

What is claimed is:

1. A device for picking up electrodes, comprising:
a variable jig movable between a first position and a second position,
wherein the variable jig is configured to (i) pick up a first-type electrode having a first mark at the first position and to (ii) pick up a second-type electrode comprising a second mark at the second position, and
wherein the first mark is different from the second mark.

2. The device according to claim 1, wherein the first-type electrode and the second-type electrode are electrodes having a same polarity.

3. The device according to claim 1, wherein the first-type electrode and the second-type electrode are electrodes having a different polarity.

4. The device according to claim 1, wherein the first mark and the second mark are notches formed at different positions such that the first mark and the second mark do not overlap with each other when the first-type electrode and the second-type electrode are overlapped.

5. The device according to claim 1, wherein the variable jig comprises a first jig and a second jig, and wherein the first jig and the second jig are configured to move toward or away from each other.

6. The device according to claim 5, further comprising:
a stationary frame comprising a rotatable pinion gear;
a first rack mounted to the first jig, the first rack being configured to move while being engaged with the pinion gear; and
a second rack mounted to the second jig, the second rack being configured to move while being engaged with the pinion gear.

7. The device according to claim 5, wherein the first jig and the second jig are disposed at different heights.

8. The device according to claim 5, wherein:
each of the first jig and the second jig comprises an identifying portion,
the first mark is configured to pass through the identifying portion of each of the first jig and the second jig in the first position, and
the second mark is configured to pass through the identifying portion of each of the first jig and the second jig in the second position.

9. The device according to claim 1, further comprising:
a base on which the variable jig is placed; and
a rail movably mounting the variable jig to the base.

10. The device according to claim 1, wherein the variable jig is provided with a tray, wherein the first-type electrode and the second-type electrode are configured to be alternately stacked on the tray.

11. The device according to claim 10, further comprising a lift actuator configured to move the tray.

12. The device according to claim 1, further comprising a transporter that is movably provided at an upper side of the variable jig and that is configured to pick up the first-type electrode and the second-type electrode.

13. The device according to claim 12, wherein the transporter is configured to pick up the first-type electrode and the second-type electrode through vacuum adsorption.

14. The device according to claim 12, further comprising a controller configured to control operation of the transporter, the controller comprising a machine vision inspector.

15. The device according to claim 14, wherein the controller is configured to:
compare, by the machine vision inspector, a set target electrode with an electrode currently picked up by the transporter with each other; and
trigger an alarm based on determining that the set target electrode and the currently picked-up electrode are different from each other.

16. A method of operating a device for picking up electrodes, the method comprising:
alternately stacking a first-type electrode having a first mark and a second-type electrode having a second mark on a tray disposed in a variable jig;
moving the variable jig to a first position based on determining that an electrode disposed at a top of the tray is the first-type electrode; and
picking up the first-type electrode using a transporter disposed at the top of the variable jig.

17. The method according to claim 16, further comprising:
moving the variable jig to a second position based on determining that the electrode disposed at the top of the tray is the second-type electrode; and
picking up the second-type electrode using the transporter.
